(19) United States
(12) Patent Application Publication
(10) Pub. No.: US 2008/0060584 A1
(43) Pub. Date: Mar. 13, 2008

(54) Hummingbird feeder

(76) Inventor: Brenda Luebke, Mountain View, CA (US)

Correspondence Address: JAMES RAY & ASSOCIATES, 2640 PITCAIRN ROAD, MONROEVILLE, PA, 15146, US

(21) Appl. No.: 11/897,799

(22) Filed: Aug. 31, 2007

Related U.S. Application Data
(60) Provisional application No. 60/843,669, filed on Sep. 11, 2006.

(51) Int. Cl. A01K 39/01

(52) U.S. Cl. 119/72

(57) ABSTRACT

An apparatus for feeding hummingbirds. The apparatus comprises a substantially hollow container member having each of a first predetermined shape and a first predetermined size and formed of a first predetermined material. The substantially hollow container member having an opening disposed on a bottom portion thereof. A nectar containing vessel engages an inner surface of the substantially hollow container member. The nectar containing vessel has each of a second predetermined shape and a second predetermined size and is formed of a second predetermined material. There is a feeding tube that is in fluid communication with the nectar containing vessel and is disposed on a bottom portion of the nectar containing vessel. The feeding tube engages the opening in the bottom portion of the substantially hollow container member.

### CROSS REFERENCE TO RELATED APPLICATION

This application is closely related to and claims benefit from U.S. Provisional Application Ser. No. 60/843,669 filed Sep. 11, 2006.

### FIELD OF THE INVENTION

The present invention relates, in general, to a hummingbird feeder, and, more particularly, this invention relates to a hummingbird feeder which incorporates replaceable premixed nectar vessels for ease in refilling and replacing food when necessary.

### BACKGROUND OF THE INVENTION

Many gardeners and bird lovers appreciate the beauty and excitement of feeding a hummingbird. Feeders that are filled with sweet and sticky nectar can keep a hummingbird feeding happily for some time. Hummingbirds get the energy they need to maintain their astonishing metabolism primarily from nectar and sugar water that is found in feeders. Hanging a hummingbird feeder means assuming a certain amount of responsibility for the well being of a fragile and trusting bird.

This is true in that it is important that feeders be cleaned periodically since it is said that hummingbirds will starve rather than consume spoiled feeder syrup. Thus, when it comes time to clean the bird feeder and replace the food the task is a necessary one but it is not a pleasant one. The owner must clean each part of the feeder. The owner also must mix the nectar for feed replacement. This is a very time consuming procedure. Sometimes this causes the owner to delay replacing the food for the hummingbird because he doesn't have the time to do it when it has to be done. When this happens the hummingbird may go without food for a period of time.

It would be advantageous to those persons that enjoy having hummingbirds if there were a simple and speedy method of cleaning the feeder and replacing fresh nectar for the hummingbird so that the bird will not go without being feed.

### SUMMARY OF THE INVENTION

In a first aspect the present invention provides an apparatus for feeding hummingbirds. The apparatus comprises a substantially hollow container member having each of a first predetermined shape and a first predetermined size and formed of a first predetermined material. The substantially hollow container member having an opening disposed on a bottom portion thereof. A nectar containing vessel engages an inner surface of the substantially hollow container member. The nectar containing vessel has each of a second predetermined shape and a second predetermined size and is formed of a second predetermined material. There is a feeding tube that is in fluid communication with the nectar containing vessel and is disposed on a bottom portion of the nectar containing vessel. The feeding tube engages the opening in the bottom portion of the substantially hollow container member.

### OBJECTS OF THE INVENTION

It is, therefore, one of the primary objects of the present invention is to provide a hummingbird feeder that uses replaceable premixed nectar vessels.

Another object of the present invention is to provide a hummingbird feeder that is easy to refill and replace food when necessary.

Still another object of the present invention is to provide a hummingbird feeder that will eliminate all the cleaning normally associated with feeders.

Yet another object of the present invention is to provide a hummingbird feeder in which the premixed nectar vessel is easily inserted into the feeding container.

An additional object of the present invention is to provide a hummingbird feeder in which the feeding tube extends out of the bottom of the feeder container.

In addition to the above described objects and advantages of the present invention, various additional objects and advantages of the recreational slides according to the instant invention will become more readily apparent to those persons skilled in the relevant art from the following more detailed description, particularly, when such description is taken in conjunction with the attached drawing figures and with the appended claims.

### BRIEF DESCRIPTION OF THE DRAWINGS

FIG. 1 is a perspective view of the container member of the apparatus for feeding a hummingbird.

FIG. 2 is a perspective view of the preassembled, prefilled nectar vessel that fits into the container member seen in FIG. 1.

FIG. 3 is a perspective view of the nectar vessel with the feeding tube extended.

FIG. 4 is a perspective view of the apparatus with the nectar vessel disposed within the container member and with the feeding tube extending out of the container member.

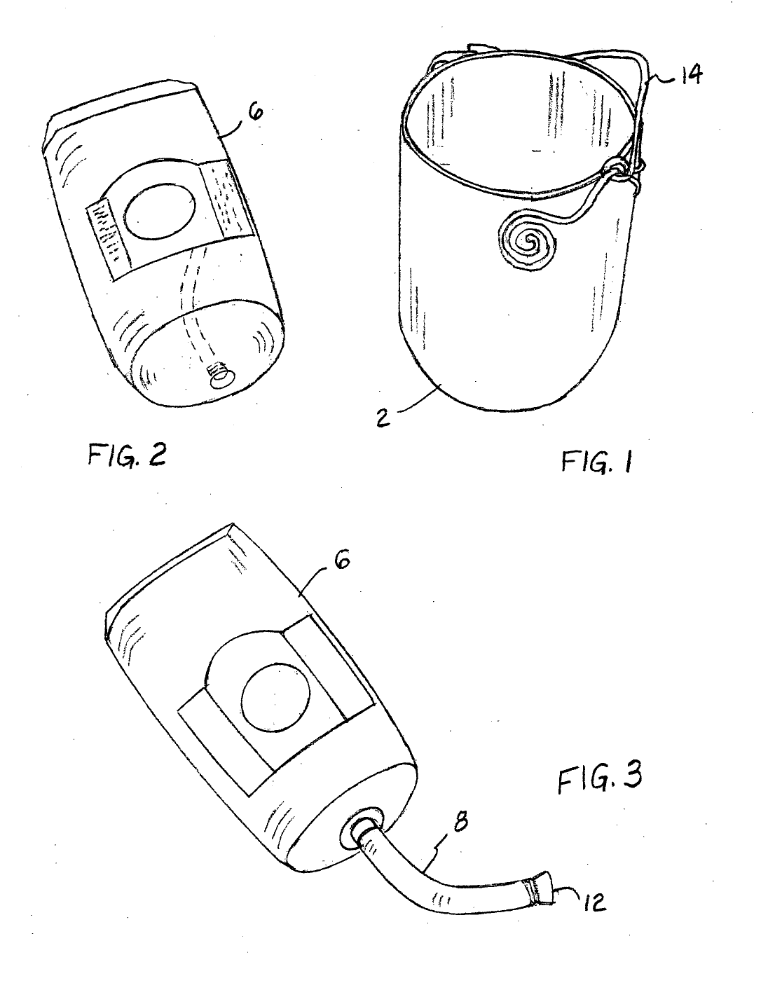

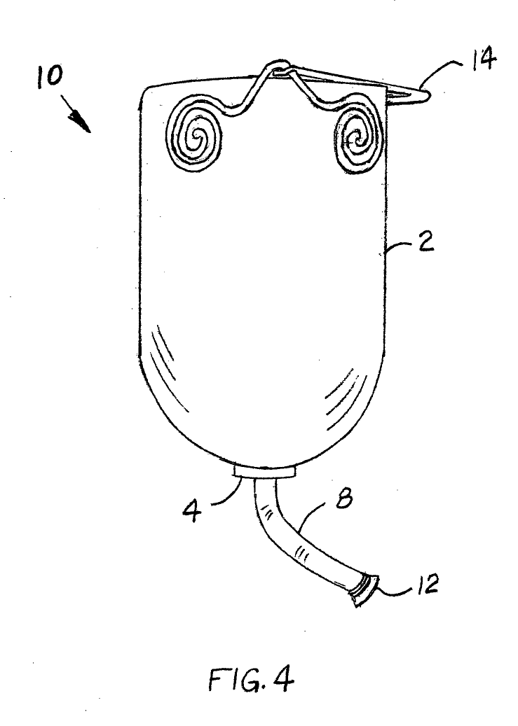

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity in understanding the invention, identical components having identical functions have been identified with identical reference numerals throughout the several views illustrated in the drawings.

In a first aspect the present invention provides an apparatus, generally designated 10, for feeding hummingbirds. The apparatus 10 comprises a substantially hollow container member 2 having each of a first predetermined shape and a first predetermined size and formed of a first predetermined material. The substantially hollow container member 2 has an opening 4disposed on a bottom portion thereof. A nectar containing vessel 6 engages an inner surface of the substantially hollow container member 2. The nectar containing vessel 6 has each of a second predetermined shape and a second predetermined size and is formed of a second predetermined material. There is a feeding tube 8 that is in fluid communication with the nectar containing vessel 6 and is disposed on a bottom portion of the nectar containing vessel 6. The feeding tube 8 engages the opening 4 in the bottom portion of the substantially hollow container member 2.

Such nectar containing vessel 8 contains premixed nectar that is ready for feeding a hummingbird. Such nectar containing vessel 8 is disposable. Since the vessel is disposable this eliminated the need for cleaning the feeder whenever it is necessary to replace the food thereby eliminating one of the most tedious jobs associated with hummingbird feeders. Also the fact that the vessel is prefilled with premixed nectar the other time consuming and daunting task for hummingbird enthusiasts is also eliminated.

So all that the user has to do is take out the old nectar containing vessel 6 and dispose of it properly when the food is gone and simply replace it with a new nectar containing vessel 6. The whole operation only takes minutes as opposed to prior art where cleaning was laborious and mixing the nectar was time consuming.

The feeding tube 8 extends downwardly through the opening in the substantially hollow container member 2. After the nectar containing vessel 6 is inserted into the hummingbird feeder 2, a gentle pull on the feeding tube 8 will release the seal with a ‘click’. The feeding tube includes an anti-drip feeding port 12 that is disposed on an outward end of the feeding tube 8. The anti-drip feeding port 12 opens when the tube is fully extended.

It is presently preferred that the nectar containing vessel 6 and the feeding tube 8 are formed as a single unit.

The second predetermined size of the nectar containing vessel 6 is substantially identical (albeit very slightly smaller) to the first predetermined size of the hollow container member 2 so that the nectar containing vessel 6 will fit snugly into the substantially hollow container 2.

Such substantially hollow container member 2 is made of one of glass, metal, wood, plastic and combinations thereof. It is presently preferred that such container member 2 is made of plastic. The container member 2 can have decorative designs disposed on the outer surface and it can be made in a variety of decorator colors.

Such nectar containing vessel 6 is also made of one of glass, metal, wood, plastic and combinations thereof. It is presently preferred that such vessel 6 be made of plastic.

The hollow container member further includes a handle member 14 that is used for hanging the apparatus 10 in a convenient location whether this is a from a pole, a branch or any other object that serves the purpose of supporting the feeder 10. Thus, the present invention provides a means easily refilling a hummingbird feeder. The nectar is premixed and placed in a nectar containing vessel which easily inserts into a hummingbird feeding container thereby providing the user with a quick and easy way to refill the unit. The pre-assembled and pre-filled nectar vessel with a feeding tube is one unit. The tube will be inside the vessel. After the vessel is inserted into the hummingbird feeder, a gentle pull on the feeding tube will release the seal with a ‘click’. The anti-drip feeding port will open when the tube is fully extended. The nectar is now available for the hummingbird and will supply the bird with all the vital nutrients necessary for the birds well being. The nectar containing vessel is disposable so the unenviable and time consuming job of cleaning the feeder is thereby eliminated. The old vessel is discarded and a new premixed and prefilled nectar vessel is placed in the feeder.

While a presently preferred and various alternative embodiments of the present invention have been described in detail above it should be understood that various other embodiments of the invention can be envisioned by those persons skilled in the art without departing from the spirit of the invention or the scope of the appended claims.

I claim:

1. An apparatus for feeding hummingbirds, said apparatus comprising:
(a) a substantially hollow container member having each of a first predetermined shape and a first predetermined size and formed of a first predetermined material, said substantially hollow container member having an opening disposed on a bottom portion thereof;
(b) a nectar containing vessel for engagement with an inner surface of said substantially hollow container member, said nectar containing vessel having each of a second predetermined shape and a second predetermined size and formed of a second predetermined material; and
(c) a feeding tube in fluid communication with said nectar containing vessel disposed on a bottom portion of said nectar containing vessel, said feeding tube for engagement with said opening in said bottom portion of said substantially hollow container member.

2. The apparatus, according to claim 1, wherein said nectar containing vessel contains premixed nectar that is ready for feeding a hummingbird.

3. The apparatus, according to claim 2, wherein said nectar containing vessel is disposable.

3. The apparatus, according to claim 1, wherein said feeding tube extends downwardly through said opening in said substantially hollow container member.

4. The apparatus, according to claim 3, wherein said feeding tube further includes an anti-drip feeding port disposed on an outward end of said feeding tube.

5. The apparatus, according to claim 4, wherein said anti-drip poring spout is open when said feeding tube is fully extended.

6. The apparatus, according to claim 1, wherein said nectar containing vessel and said feeding tube are formed as a single unit.

7. The apparatus, according to claim 1, wherein said second predetermined size is substantially identical to said first predetermined size so that said nectar containing vessel fits snugly into said substantially hollow container.

8. The apparatus, according to claim 1, wherein said container member is made of one of glass, metal, wood, plastic and combinations thereof.

9. The apparatus, according to claim 8, wherein said container member is made of plastic.

10. The apparatus, according to claim 1, wherein said nectar containing vessel is made of one of glass, metal, wood, plastic and combinations thereof.

11. The apparatus, according to claim 10, wherein said nectar containing vessel is made of plastic.

12. The apparatus, according to claim 10, wherein said substantially hollow container member includes a handle member engageable with an upper portion of said hollow container member for hanging said apparatus.
